(19) United States
(12) Patent Application Publication
(10) Pub. No.: US 2014/0139555 A1
(43) Pub. Date: May 22, 2014

(54) METHOD OF ADDING EXPRESSION TO TEXT MESSAGES

(71) Applicant: ChatFish Ltd, Nahariya (IL)

(72) Inventor: SHOHAM LEVY, Nahariya (IL)

(73) Assignee: ChatFish Ltd, Nahariya (IL)

(21) Appl. No.: 14/085,826

(22) Filed: Nov. 21, 2013

Related U.S. Application Data
(60) Provisional application No. 61/728,815, filed on Nov. 21, 2012.

(51) Int. Cl. G06F 17/21; G06T 11/60

(52) U.S. Cl. CPC G06F 17/212; G06T 11/60
USPC 345/636; 715/202

(57) ABSTRACT

A string of input characters is received through an input device and associated with an audio stream with at least one character of the string being associated with at least one sound of the audio stream, and each association is stored in a memory for synchronized playback. An electronic text message is associated with an image file, the association including an instruction to output the electronic text message concurrently with the image file such that the image file is output as a background image to the electronic text message. One or more text strings in an electronic text message is associated with one or more other text strings, and the one or more other text strings and associations, which may include start and end indexes, are stored in a memory as tags for the electronic text message.

### CROSS-REFERENCE TO RELATED APPLICATION

This application claims the benefit of U.S. Provisional Application No. 61/728,815, filed 21 Nov. 2012.

### FIELD AND BACKGROUND OF THE INVENTION

The present invention relates generally to methods of adding expression to electronic text messages. In one aspect the present invention relates to a method of synchronizing a text string to an audio stream for delivery in an electronic text message. In another aspect the present invention relates to sending and receiving electronic text messages together with one or more background images for displaying the text message. In yet another aspect the present invention relates to tagging electronic text messages.

### SUMMARY OF THE INVENTION

According to a first aspect of the present invention there is provided a method of creating an expressive electronic text message including, by a computing device (a) receiving a string of input characters through an input device (b) associating the string with an audio stream such that at least one character of the string is associated with at least one sound of the audio stream; and (c) storing each of the associations in a memory.

The step of associating may be performed concurrently with the step of receiving or subsequent to the step of receiving. The set of associations may be created automatically or in response to an instruction from a user. Preferably, the string is output concurrently with the audio stream. Preferably, each of the at least one characters is output simultaneously with the at least one sound with which it is associated. Preferably, each of the at least one characters is emphasized simultaneously with the output of the at least one sound with which it is associated. Preferably, the emphasizing includes animating, resizing, reorienting, repositioning, or recoloring the at least one character.

According to another aspect of the present invention there is provided a method of adding expression to an electronic text message including (a) at a first computing device: creating an association of an electronic text message with a computer readable image file, wherein the association includes an instruction for outputting the electronic text message concurrently with the image file such that when the electronic text message is output on a display of a computing device, the image file is output as a background image to the electronic text message.

Preferably, the method includes identifying one or more keywords in the electronic text message and identifying one or more image files related to the one or more keywords. Preferably, the method includes (b) transmitting to a second computing device the electronic text message and the instruction. Preferably, the method includes, at the second computing device: (c): receiving the electronic text message and the instruction from the first computing device, and executing the instruction. Preferably, the instruction includes a reference to a downloadable image file, and the executing includes downloading the image file corresponding to the reference. Preferably, the method includes (d) adjusting one or more display properties of the associated image file.

In another aspect of the present invention there is provided a method of tagging an electronic text message stored in a memory of a computing device including, by the computing device: (a) associating at least one first text string within the electronic text message with at least one second text string, and (b) storing the second text string and the association in the memory. Preferably, the electronic text message is an instant message. Preferably, the at least one first text string is only a portion of the electronic text message, and the association includes a reference to at least a start position of the at least one first text string.

In another aspect of the present invention there is provided a computer readable storage medium having computer readable code embodied thereon for creating an expressive electronic text message, the computer readable code including: (a) program code for receiving a string of input characters; and (b) program code for associating the string with an audio stream such that at least one character of the string is associated with at least one respective sound of the audio stream, thereby creating, for each of the at least one characters, a respective association, wherein the at least one association is stored in the computer readable storage medium.

In another aspect of the present invention there is provided a computer readable storage medium having computer readable code embodied thereon, the computer readable code for adding expression to an electronic text message, the computer readable code including program code for associating an electronic text message with a computer readable image file, thereby creating an association of the electronic message with the computer-readable image, wherein the association includes an instruction to output an image stored in the associated image file concurrently with, and in the background of, an output of the electronic text message.

In another aspect of the present invention there is provided a computer readable storage medium having computer readable code embodied thereon, the computer readable code for tagging an electronic text message, the computer readable code including program code for associating at least one first text string within the electronic text message with at least one second text string, thereby creating an association of the at least one first text string with the at least one second text string, wherein the at least one second text string and the association is stored in the computer readable storage medium.

### BRIEF DESCRIPTION OF THE DRAWINGS

Various embodiments are herein described, by way of example only, with reference to the accompanying drawings, wherein:

FIG. 1 is a visual conceptualization of a synced string according to the present invention;

FIG. 2 is a visual conceptualization of an embodiment of a text input stage of the present invention;

FIG. 3 is a visual conceptualization of another embodiment of a text input stage of the present invention;

FIG. 4 is a process flow chart of an embodiment of a music selection process;

FIG. 5 is a high level block diagram of a synced string delivery system according to the present invention;

FIG. 6 is a process flow chart for a method of receiving a text message with one or more background images at a receiving device according to the present invention;

FIG. 7 is a conceptual illustration of messages with corresponding tags according to the present invention;

FIG. 8 is a conceptual illustration of text items with a part of the text tagged according to the present invention.

FIG. 9 is a high-level partial block diagram of an exemplary computer system configured to implement the present invention.

### DESCRIPTION OF THE PREFERRED EMBODIMENTS

The principles and operation of methods of adding expression to electronic text messages according to the present invention may be better understood with reference to the drawings and the accompanying description. As used herein “electronic text message” includes any text-based document in electronic format such as email, SMS/MMS, IP based instant messaging protocols (such as XMPP, AIM, Skype, etc.), documents containing text strings which are displayed to a user, such as word processing documents, spreadsheets, etc., HTML/XML pages, or any electronically rendered text.

In one aspect the present invention relates to a method of synchronizing a text string in an electronic text message to an audio stream which may then be used for delivery in an electronic text messaging system. By “synchronize” we mean specific positions along the text string (for example characters or character groups) are associated with corresponding specific positions along the audio stream (for example specific time positions). These positions are referred to herein as “sync points”. A sync point can be thought of as binding one or more contiguous characters in a text string to one or more contiguous sounds in an audio stream. As used herein, a “sound” includes a combination of simultaneous sounds. A sound does not have to be a musical sound; rather as used herein a sound is anything that can be audibly output by a computer. A sound can be a single distinct audible element or a combination of audible elements (e.g. a trumpet and a guitar). A text string synchronized (or “synced”) to an audio stream along specific sync points is referred to herein as a “synced string”. The synced string is stored in a computer memory for later playback. It is contemplated that the synced string is played back through a computing device which includes or is connected to a visual display for outputting text and which includes or is connected at least one speaker for outputting audio. By “playing back” a synced string we mean concurrently outputting the text string and audio stream so that the output of both appear to be synchronized, that is the text string is presented to a viewer in sync with the audio playing, as defined by the stored sync points. By “computing device” we mean any device, machine, apparatus or system which has at least a microprocessor and a memory, in which the microprocessor is capable of executing instructions stored in the memory. Playing back a synced string adds another expressive element to the simple text embedded in the string, for example by portraying a mood as expressed by the audio stream which may otherwise not be apparent from the text itself.

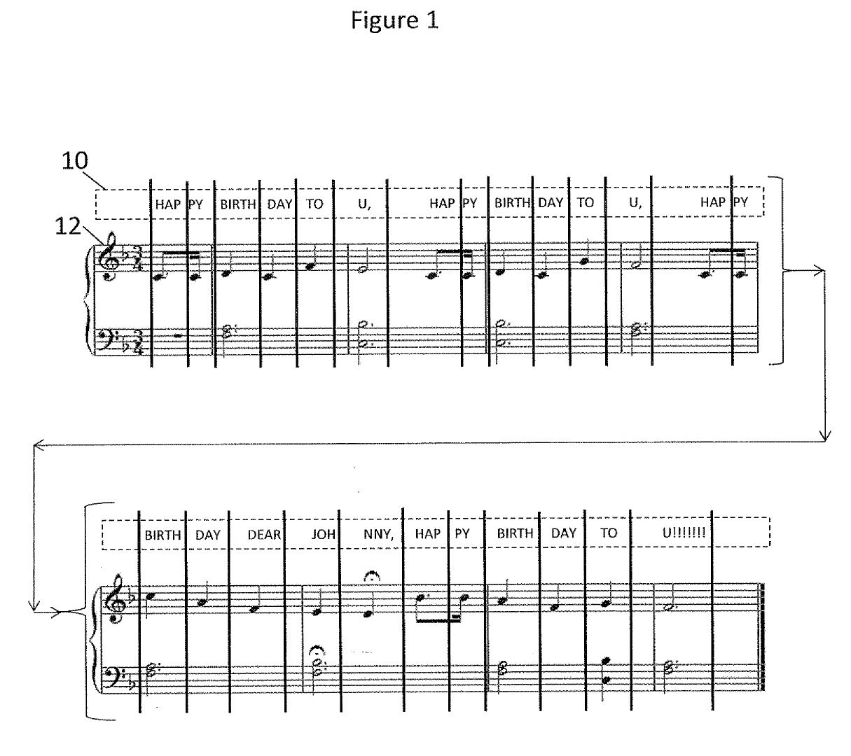

Referring now to the drawings, FIG. 1 is a visual conceptualization of a synced string according to the present invention. A text string 10 displaying a happy birthday message to a boy named Johnny is shown which is synchronized to an audio stream 12. in this case audio stream 12 is shown as a visual representation of the popular song “Happy Birthday”. Both text string 10 and audio stream 12 are divided into a number of individual segments (separated by dashed vertical lines in FIG. 1). Segments can vary in length. Each segment corresponds to a particular position or section along the text string and a corresponding position or section along the audio stream. As shown in FIG. 1, each segment of text string 10 is bound to a particular segment of audio stream 12, representing the sync points. Upon playback of Johnny's happy birthday message, audio stream 12 is played concurrently with segments of text string 10 being output. Each segment of text string 10 is output only when the corresponding segment of audio stream 12 is played.

The present invention contemplates that the synced string may be played back in a number of different ways. For example as the audio is played, text string elements, such as characters or character groups, may visually appear and subsequently disappear to be replaced with the next text string elements. Alternatively, as the audio stream is played, the corresponding text string elements may appear be appended to text string elements already displayed, so that the text string develops to completion as the audio plays. In yet another alternative, the entire text string (or substrings thereof) may be presented all at once, whereupon individual text elements become animated, resized, repositioned, recolored, reoriented or otherwise emphasized when concurrently playing audio reaches the corresponding sync point. In addition, control may be given to either the creator of the synced string or the recipient (i.e. the one who plays it) to determine which of all possible playback methods are to be used to playback the synced string.

Input Method

Various input methods for creating a synced string will now be described. The input stage consists of the steps of selecting audio, inputting text, and creating sync points, though not necessarily in that order. In the audio selection stage, a user may select a desired audio stream from one or more libraries of audio files. Alternatively a user may instruct the computing device to “intelligently” select an audio stream or present a list of choices of audio streams from one or more libraries based on keywords (or tags) which the computing device may extract from the text string.

A “library” is used herein to denote a collection of computer readable files which may be stored in a computing device, though not necessarily in the same folder or even the same device. For example a library may include files stored on a remote computing device or in a “cloud” computing environment. A user may choose files from different locations to be aggregated into a library. A library can potentially include any computer readable audio file in any file format, for example .wav, .mp3, .wmv, etc. A library may include audio streams from any source including user created/recorded as well as commercially published content. A library may include audio streams which are available to download and use for free as well as those required to be purchased. In one embodiment, a method of creating a synced string according to the present invention includes providing a user the ability to download audio for free or for purchase from a remote server for use in creating the synced string. Methods of facilitating the purchase and transfer of audio files from a remote server to a computing device requesting the purchase are well known to those skilled in the art and need not be described in detail herein.

Furthermore, a user may choose to select an entire audio stream or only a portion thereof, the selected portion becoming the “new” audio stream for binding to a text string. Alternatively two or more audio streams or portions of audio streams may be selected and joined to form a new audio stream for binding to a text string. In one embodiment, the user may also be able to modify aspects of the audio stream, or aspects of specific portions of the audio stream, such as tempo, volume, pitch, etc. In one embodiment, a user may instruct a computing device to perform a modification on the audio stream by the user registering an input action at the computing device while the audio stream is being played. Input actions include any method of receiving user input that may be available on the computing device such as keyboard/mouse input, taps, shakes, gestures, microphone, etc.

During the text input stage, a user types a text string into a computing device while the computing device records the typed text. In one embodiment, the computing device may also record related information, such as the speed at which the characters are input, the length of pauses between characters, and the presence of deletions and/or corrections to the typed text string. This related information may be used during the playback stage to influence playback. If the audio stream is played for the user while the user types, the computing device may also record various components of the audio stream being played (e.g. tempo etc.) which can also be stored and used to affect the playback.

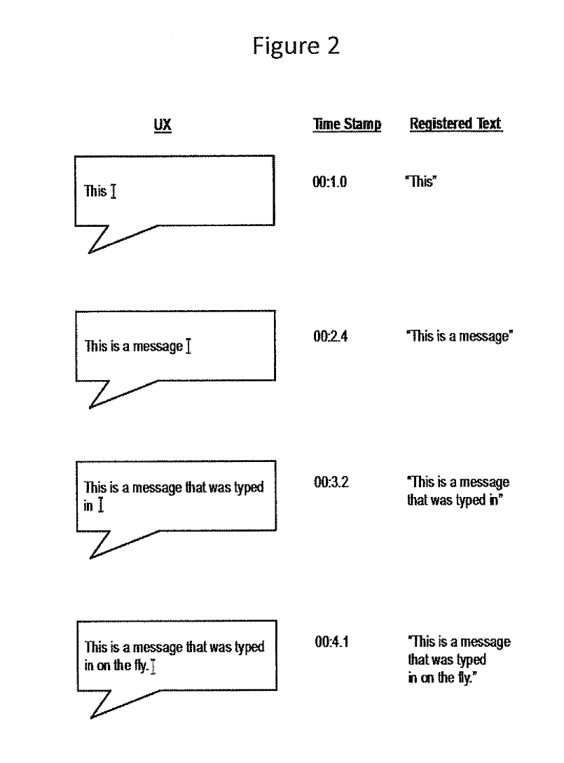

Next, the syncing stage will be described. In one embodiment, sync points are determined automatically by the computing device and recorded by the computing device as the text string is being input by the user. This embodiment is illustrated in FIG. 2, which is a visual conceptualization of an embodiment of a text input stage of the present invention. A user enters some text into a computing device through an input terminal, preferably while the selected audio is being played, although not necessarily. The computing device records the time as the text is being entered and synchronizes the audio stream playback according to the timing of the text input. In FIG. 2, the synced string may be synchronized so that 1 second into the audio stream the text displayed is “This”, 2.4 seconds into the audio the text displayed is “This is a message”, 3.2 seconds into the audio the text displayed is “This is a message that was typed in”, and 4.1 second into the audio the text displayed is “This is a message that was typed in on the fly”.

In this embodiment, the specific sync points can be determined in a number of different ways, for example by metronome ticks, fixed or variable time intervals, keystrokes, CTL timecode, SMPTE time code, or specific audible elements of the audio stream which may be detected by the computing device (e.g. solo note on/off, musical phrases, MIDI system exclusive commands). Alternatively, the user can be responsible for assigning sync points. In one embodiment, a user may assign sync points as the user types the text, for example by tapping a dedicated key which, instead of entering a text character, instructs the computing device to assign a sync point.

In another embodiment, a user first types the complete text string and subsequently assigns sync points. In this embodiment, subsequent to the user inputting a text string the user may be shown the text string and asked to sequentially select various positions along the text string while the audio is being played. Each time the user selects a position along the text string, the computing device records the user's selection and the current position in the playing audio stream, and assigns a sync point.

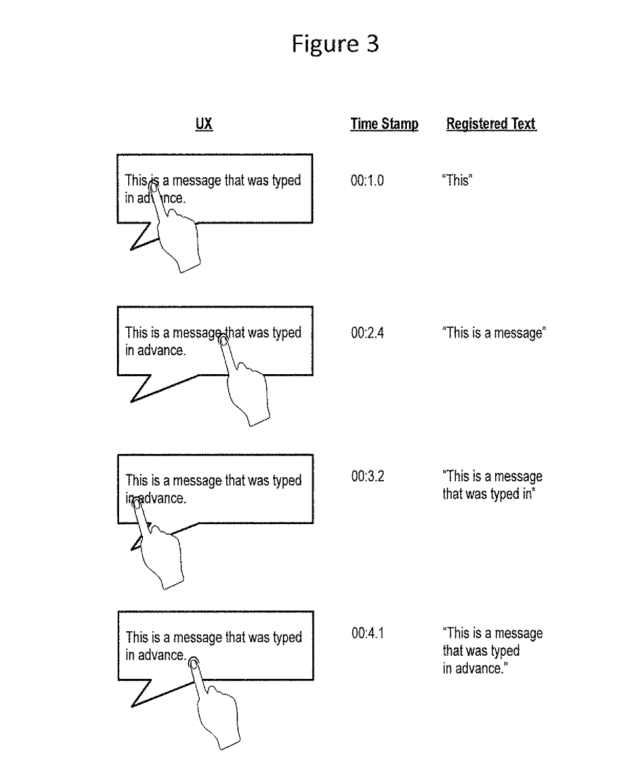

This embodiment is illustrated in FIG. 3, which is a visual conceptualization of an embodiment of a text input stage of the present invention. A user enters the complete text string “This is a message that was typed in advance” into a computing device through an input terminal. Once the text entry is complete, the audio begins to play. As the audio is being played, the user taps parts of the text string, where each tap is interpreted by the computing device as an instruction to assign a sync point. Selections can also be made with a mouse if the display of the computing device is not a capacitive touch screen. In the example shown in FIG. 3, the sync points are the same as in FIG. 2, however in FIG. 3 the sync points are assigned only after the entire text string is input.

Use in Instant Messaging

In one embodiment, a synced string may be used in conjunction with an instant messaging program to send expressive text messages. Instant messaging programs are well known in the art. Generally, an instant messaging program includes at least an instant messaging client program which is installed on a sending computing device and receiving device and an instant messaging server program installed on a remote computing device that acts as a gateway between instant messaging clients and facilitates transfer instant messages between clients. In one embodiment of the present invention, an instant messaging client program includes functionality for creating and playing back a synced string. In one embodiment, the instant messaging program may include functionality for searching, importing, and purchasing audio files for use in creating a synced string. In one embodiment the instant messaging program may include functionality for searching a text string for keywords, and searching and identifying suitable audio files for use in creating a synced string.

Music Selection

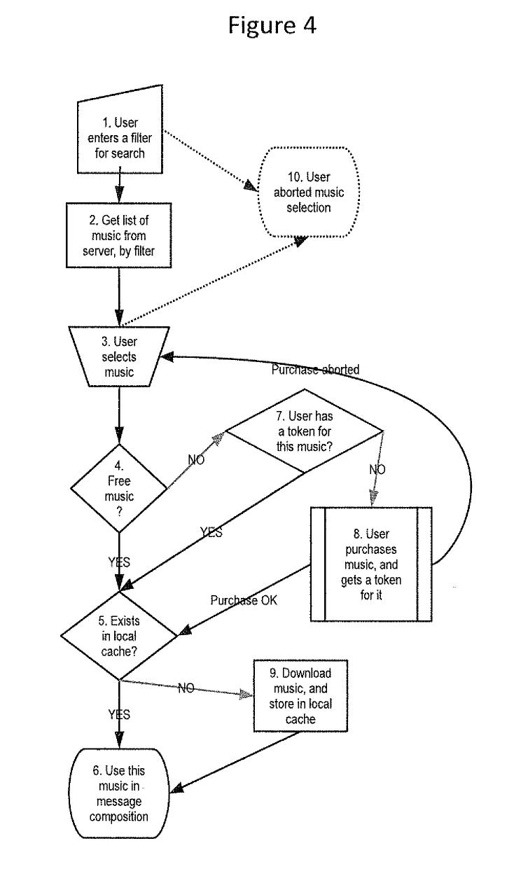

FIG. 4 is a process flow chart of an embodiment of an audio stream selection process where the audio stream is music. In Step 1 the user may manually filter music, or a filter may be created automatically. In Step 2 the server uses the filter to select relevant music, and show the user a prioritized list of relevant music according to an internal prioritization system. In Step 3 the user selects a piece of music, which may free or may need to be purchased. In Step 4, if the selected music is free, the process continues to Step 5. However if the music is required to be purchased, the process continues to Step 7 where the music purchase is validated by a token or other indicator of authorization to use purchased music. If a token is available, the process continues to Step 5; if not the process first continues to Step 8 where the music is purchased and a token is acquired, following which the process continues to Step 5. In Step 5, the local cache is checked to see if the selected music exists in the cache which may be emptied at predetermined intervals. If the selected music exists in the cache, the process continues to Step 6; if not, the process continues to Step 9 where the music is fetched from the server to the local cache, and from there the process continues to Step 6. In Step 6, the music selection process is completed and the selected music may then be used to create the synced string. In Steps 1, 3, and 8 the user may instead choose to the abort music selection at this stage, in which case the process continues to Step 10.

Delivery

In one embodiment, the synced string may be delivered to a recipient via an electronic messaging application. One example of an electronic messaging application is the instant messaging program described above. However, any electronic message delivery system may be used so as long as the recipient computing device contains computer readable code for reading, decoding, and playing back the synced string.

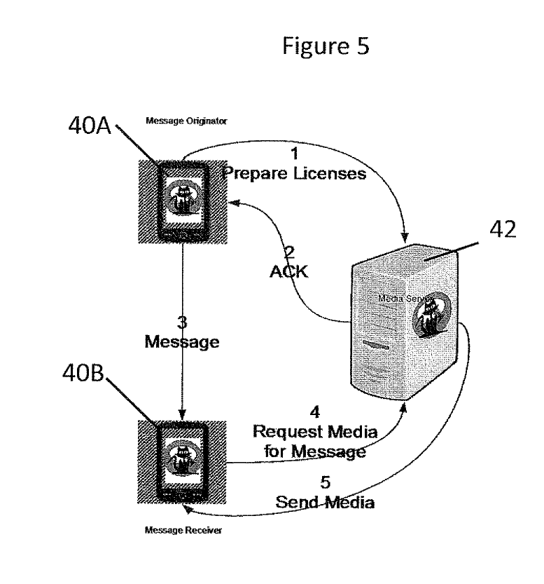

FIG. 5 is a high level block diagram of a synced string delivery system according to the present invention. In FIG. 5, a sending mobile device 40A delivers an instant message to a receiving mobile device 40B where the message includes a synced string. Sending mobile device 40A first communicates with a media server 42 to prepare the required licenses for the audio selection and provide an acknowledgement of authorization to use the selected music, for example via a token or cookie which downloaded to sending mobile device 40A. Sending mobile device 40A then creates the synced string and sends a message to receiving mobile device 40B which includes the text string and embedded data providing instructions for receiving mobile device 40B to reproduce the synced string, including a description of an audio stream and sync points. Alternatively sending mobile device 40A may provide receiving mobile device 40B with the cookie. Receiving mobile device 408 follows the embedded instructions to request an audio stream from media server 42. If cookies are used to verify audio purchases, receiving mobile device 40B may provide to media server 42 the cookie which receiving mobile device 40B received from sending mobile device 40A. Upon receiving the request, media server 42 verifies the license for the audio stream, for example by validating the cookie provided by receiving mobile device 40B. Media server 42 then provides receiving mobile device 40B with the requested audio stream. Finally, receiving mobile device 40B reproduces the synced string using the text and sync points provided by sending mobile device 40A and the audio stream downloaded from media server 42.

Playback

As previously described, the present invention contemplates different methods of playing back a synced string, since it some instances it may be desirable for a message sender (which can be a user or a sending computing device) to determine how the message is to be played back while in other instances it may be desirable for a message recipient (a user or a receiving computing device) to modify various components of play back such as how the text is displayed (e.g. static, animated, marquee, etc.) or how the audio is played (e.g. volume, pitch, etc.). Preferably, the receiving computing device contains computer readable code for playing synced strings, however if not the receiving computing should at least be able to display the simple text string and/or provide a link where a user can download code for playing synced strings.

Using Background Images to Add Expression to Text Messages

Another aspect of the present invention relates to a method of adding expression to electronic text messages by creating an association between the electronic text message and an image file which is to be used as a background image while the electronic text message is displayed. The created association can include an instruction which, when executed by a computing device, causes the image stored in the image file to be displayed on a display device concurrently with the electronic text message as a background image to the electronic text message. The electronic text message and instruction for displaying an associated image file can also be sent from one computing device to one or more other computing devices together with the image file or a link to the image file.

In one embodiment a message sender (which could be a user or a computing device) sends one or more electronic text messages to one or more message recipients (which could be users or computing devices). In one embodiment the electronic text message may contain an empty text string, or one or more non-empty text strings, and may be associated with none, one, or more images. In one embodiment, the electronic text message and instruction to display any associated images are sent to a message recipient. When received by the message recipient, the receiving computing device executes the instruction and the one or more associated images are displayed on the receiving computing device as background images while the text string appears in the foreground. Electronic text messages may be sent and received using known and existing electronic text messaging protocols. In one embodiment, electronic text messages are delivered via an instant messaging system such as the instant messaging system described above in relation to synced strings. The text string component of the electronic text message may be sent using existing protocols for communicating text messages, such as those used by chat programs which are well known to those skilled in the art, while the image component of the message may be sent in the same or a different way. For example the image may be sent in-band (i.e. using the same transport layer as the electronic text message itself) if the protocol supports image delivery, or by direct peer-to-peer connection which may be negotiated within an electronic text messaging session, or by using a third party repository to hold the images, or by any other means known in the art.

In one embodiment the images are selected automatically from a set of images which is pre-defined by the user. For example the user may define an image directory containing image files, or may specify a set of images tagged with a specific date range or geo-tagged with specific locations. In another embodiment, the user manually selects the images to send. In one embodiment, images may be selected from images created by the user and may also be selected from an image library for free or for purchase. In one embodiment, images are automatically selected based on keywords in the text or by intelligently mining the text of contained within the electronic text message for one or more themes and selecting relevant images based on those themes. Image tags may be used to identify a theme associated with an image. In one embodiment images are selected randomly. In one embodiment, images may be updated dynamically as the chat (i.e. messaging session) progresses. In one embodiment, the sequence of images may be determined randomly, chronologically, or context-based on the message content.

The following examples illustrate how background images may be used to add expressiveness to electronic text messages:
1. A boy, and his girlfriend are chatting. Each chooses a set of his/her own images for sending the other party. The sent images are used by the receiver to set the background of the text message in the receiver's display screen.
2. While on a trip, a person text messages his friend using images of the trip as the background scene of the text messages.
3. While sending a person an angry text message, the text message is detected as containing an angry theme and a picture of an angry dog is selected by the system as a background image to the angry text.

In one embodiment, an image file is sent by the sending device directly to the receiving device. In another embodiment, an image file is sent by the sending device to a media server, and the receiving device downloads the image from the media server using an image identifier (such as an MD5 sum) which the receiving device receives from the sending device. In another embodiment, the sending device sends the receiving device a link, such as a URL, from where the receiving device can download the image from a media server. In one embodiment, the image file is compressed to save bandwidth during transmission. In one embodiment, the receiving device may automatically adjust aspects of the image to fit the receiving device's display. For example the image may be resited, cropped, or adjusted for color, contrast, etc. In one embodiment, the receiving device may delay displaying the text component of the electronic text message until the background image is displayed on the screen. In one embodiment the receiving device may store the received image in a cache. In one embodiment, the receiving device may automatically replace the background image when a new one is received at the receiving device, or only upon the receiving user acting on the received message, such as opening the message or clicking on the message or associated image download link. In one embodiment the background image may be updated even if no new text is received.

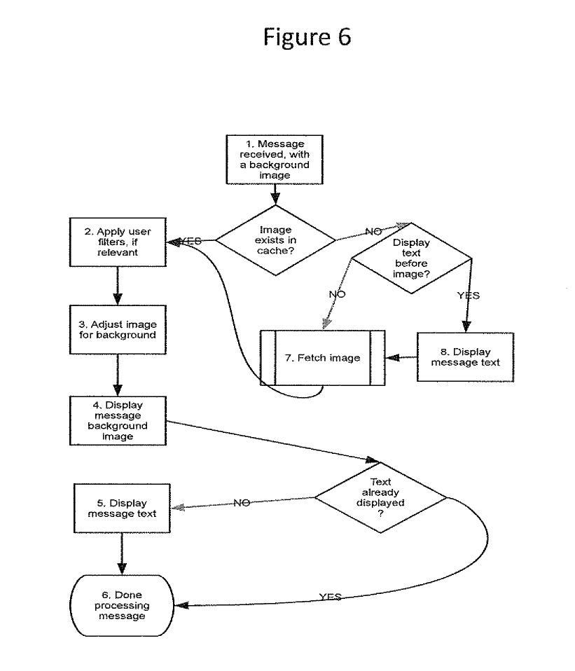

FIG. 6 is a process flow chart for a method of receiving an electronic text message with one or more associated background images at a receiving device according to the present invention. In Step 1 the receiving device receives an electronic text message with an associated background image identifier, and an instruction to display the associated image as a background to the electronic text message. If the image already exists in the receiving device's cache, the process continues to Step 2; if not, depending on whether the receiving device is set to display the text before the image, which may depend on user preferences as stored within the receiving device, the process continues to either Step 8 where the text is displayed and then to Step 7 where the image is retrieved or “fetched” from a media server, or the process may continue directly to Step 7 where the image is fetched before any text is displayed. The process continues to Step 2 where any image filters are applied. In Step 3 the image is adjusted or manipulated to fit the display or adjust the color scheme. In Step 4 the adjusted image is displayed in the background unless a newer message with an image was received while processing this image, in which case this image will not be displayed. From Step 4 the process continues to either Step 5 where the message text is displayed and then to Step 6, or directly to Step 6 if the text was already displayed in Step 8. In Step 6 the process is completed.

Electronic Text Message Tagging

Yet another aspect the present invention relates to tagging electronic text messages. Another aspect of the present invention relates to tagging messages, for example messages in a chat session. “Tagging” an electronic text message refers to assigning a keyword or term (“tag”) to an electronic text message that describes the subject of the text content of the message in order to quickly search, aggregate, and display messages containing related content. Tags may be created on the computing device in which an electronic text message is created or stored, either automatically without requiring user input or after receiving an instruction from a user to create a tag, or both. The following are examples of how tags may be used:
1. A user planning a vacation sends and receives text messages containing information from travel agents as well as messages from friends with recommendations for the trip. The user may tag the messages with “AmsterdamTrip”.
2. A user is planning an event using some individual chats (one on one), and some group chats. The user may tag all messages where someone commits to bringing something to the event with the tag “bringing_to_party”.
3. A user may like to keep a collection of wise quotes from chats with friends using a tag “friends_wisdom”.

In one embodiment a single electronic text message can have an indefinite number of tags. In one embodiment a tag may be applied explicitly, meaning a user (or a computing device) may create a custom tag subsequent to creating or receiving the text content of the message which tag may or may not be apparent from within the message content. In another embodiment a user may create an implicit tag during the message creation stage by inserting a hashtag (a word prefixed by “#”) somewhere in the message. A computing device is configured to detect the existence of a hashtag in messages and automatically create a tag for the message with the name of the tag corresponding to the hashtag. In one embodiment tags may be added, removed, or edited without affecting the message.

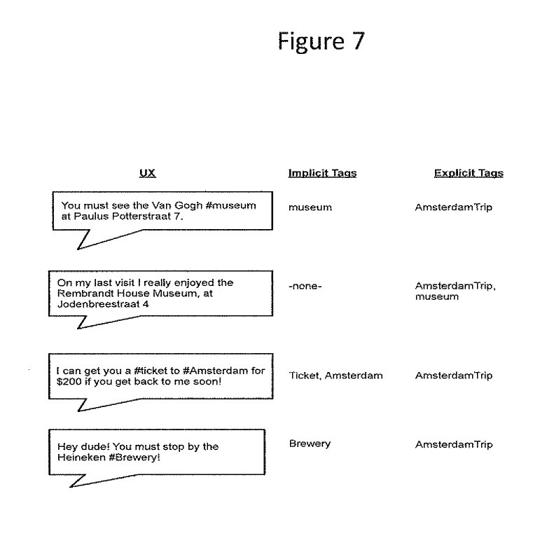

FIG. 7 is a conceptual illustration showing messages with corresponding tags according to the present invention. A number of examples are shown in FIG. 7 where implicit and/or explicit tags are applied to text messages. As can be seen in FIG. 7, a message may have an implicit tag, an explicit tag, or both implicit and explicit tags. In addition, a message may have none, one, or more implicit or explicit tags.

Partial Text Tagging

In one embodiment a tag may be applied to only a portion of an electronic text message, such as a specific text string within the text message. Referred to herein as “offset tags” these tags identify a specific portion of text within a text message. An offset tag may be constructed by having a user, or a computing device, select some text from an electronic text item and performing an instruction to assign a tag to the selected text. In one embodiment the offset tag contains a reference to the text item, a start index such as a number of characters into the text item where the offset tag is to be applied, and optionally an end index identifying where the offset tag ends, for example by reference to the number of characters into the text.

Although the above discussion relates to electronic text messages, it is contemplated that even non message-type electronic text items may be tagged according to one of the methods of the present invention such as word processing documents, HTML based web pages, etc. or any electronically rendered text stored in a computer memory.

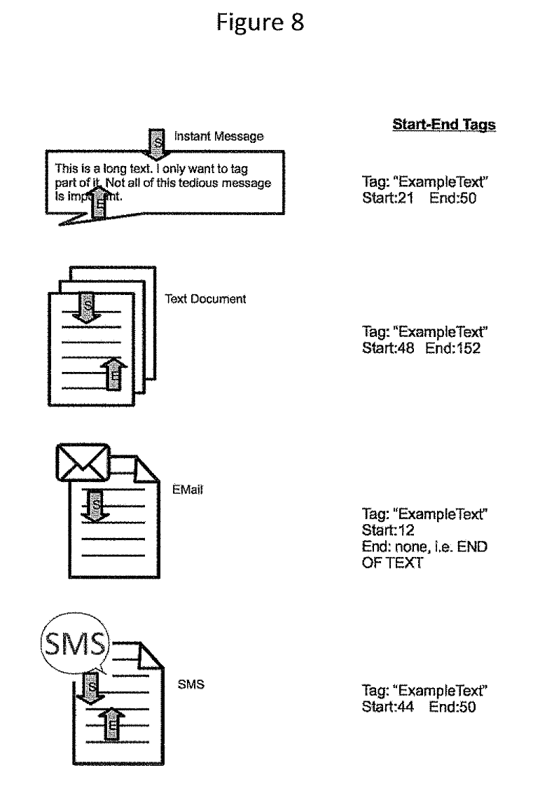

FIG. 8 is a conceptual illustration of text items with a string of text tagged by an offset tag according to the present invention. FIG. 8 shows the following examples of partial text tagging:

1. An instant message text item with the string “I only want to tag part of it” tagged as “ExampleText” with a start index of 21 and end index of 50, since the tagged text begins with the 21st character and ends with the 50th character (starting from 0 as the number of the first character).

2. A text document wherein a particular string (the contents of which are not shown) is tagged as ExampleText with a start index of 48 and end index of 152;

3. An email wherein a particular string (the contents of which are not shown) is tagged as ExampleText with a start index of 12 and no end index. In this case the tagged string ends at the end of the email text;

4. An SMS wherein a particular string (the contents of which are not shown) is tagged as ExampleText with a start index of 44 and end index of 50.

As can be seen from FIG. 8, an offset tag may contain both a start index and end index, or only a start index. In one embodiment the absence of an end index implies that the tagged string ends at the last character of the text item.

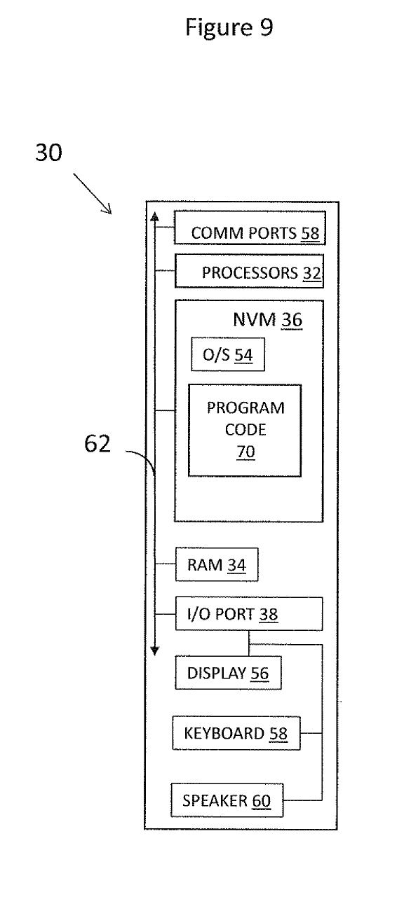

FIG. 9 is a high-level partial block diagram of an exemplary computer system 30 configured to implement the present invention. Only components of system 30 that are germane to the present invention are shown in FIG. 9. Computer system 30 includes one or more processors 32, a random access memory (RAM) 34, a non-volatile memory (NVM) 36, communication ports 58, and an input/output (I/O) port 38 (which is operatively connected to one or more of a display 56, a keyboard 58, and a speaker 60) all communicating with each other via a common bus 62. In NVM 36 are stored operating system (O/S) code 54 and program code 70 of the present invention. Program code 70 is computer readable executable code for implementing the present invention.

In one embodiment, program code 70 includes code for creating a synced string according to the principles of the present invention. Under the control of O/S 54, one or more processors 32 loads program code 70 from NVM 36 into RAM 34 and executes program code 70 in RAM 34 to create a synced string using a text string which is received via I/O port 38 from keyboard 58 and an audio stream stored in NVM 36. The execution of program code 70 associates one or more adjacent characters of the text string with one or more adjacent sounds in the audio stream and stores the associations in NVM 36. If desired, the text and audio component of the synced string can be concurrently output through display 56 and speaker 60. Alternatively the synced string can be transmitted via communication ports 58 to a second computer system.

In another embodiment, program code 70 includes code for creating an association with an electronic text message and an image file, and an instruction to display the image in the background of the electronic text message according to the principles of the present invention. Under the control of O/S 54, one or more processors 32 loads program code 70 from NVM 36 into RAM 34 and executes program code 70 in RAM 34 to associate an electronic text message with a background image. The execution of program code 70 creates an association between an electronic text message received at I/O port 38 or communication ports 58 and stored in NVM 36, and a computer readable image file. The association includes an instruction to display the image stored in the image file concurrently with, and in the background of, the electronic text message. If desired, the electronic text message and associated image can be concurrently output to display 56. Alternatively the electronic text message and associated image including instruction can be transmitted via communication ports 58 to a second computer system.

In yet another embodiment, program code 70 includes code for tagging an electronic text message according to the principles of the present invention. Under the control of O/S 54, one or more processors 32 loads program code 70 from NVM 36 into RAM 34 and executes program code 70 in RAM 34 to tag an electronic text message with one or more tags. The execution of program code 70 associates all or part of an electronic text message received at I/O port 38 or communication ports 58 and stored in NVM 36 with one or more text string tags. Each association, which may also include a reference to a start or end position of a text string within the electronic text message, is stored in NVM 36.

NVM 36 is an example of a computer-readable storage medium bearing computer-readable code for implementing the data validation methodology described herein. Other examples of such computer-readable storage media include read-only memories such as CDs bearing such code.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A computer implemented method of creating an expressive electronic text message comprising, by a computing device:
(a) receiving a string of input characters through an input device operatively connected to the computing device;
(b) associating said string with an audio stream such that at least one character of said string is associated with at least one respective sound of said audio stream; and
(c) storing each said association in a memory operatively connected to the computing device.

2. The method of claim 1 wherein the step of associating is performed concurrently with the step of receiving.

3. The method of claim 1 wherein the step of associating is performed subsequent to the step of receiving.

4. The method of claim 1 wherein the computing device associates each said at least one character with said respective sound thereof in response to an instruction from a user.

5. The method of claim 1 wherein the computing device automatically associates said at least one character with said respective sound thereof.

6. The method of claim 1 further comprising outputting said string concurrently with said audio stream.

7. The method of claim 6 wherein each said at least one character is output simultaneously with said at least one sound associated therewith.

8. The method of claim 6 wherein said outputting includes emphasizing said at least one character simultaneously with said output of said at least one sound associated therewith.

9. The method of claim 8 wherein said emphasizing includes animating, resiting, reorienting, repositioning, or recoloring said at least one character simultaneously with said output of said at least one sound associated therewith.

10. A computer implemented method of adding expression to an electronic text message comprising:
(a) at a first computing device:
creating an association of an electronic text message with a computer readable image file, wherein said association includes an instruction for outputting said electronic text message concurrently with said image file such that when said electronic text message is output on a display of a computing device, said image file is output as a background image to said electronic text message.

11. The method of claim 10 further comprising, by the first computing device, identifying one or more keywords in the electronic text message and identifying one or more image files related to said one or more keywords.

12. The method of claim 10 further comprising:
(b) at the first computing device, transmitting to a second computing device said electronic text message and said instruction.

13. The method of claim 12 further comprising:
(c) at said second computing device:
(i) receiving said electronic text message and said instruction from said first computing device, and
(ii) executing said instruction.

14. The method of claim 13 wherein said instruction includes a reference to a downloadable image file, and wherein said executing includes downloading the image file corresponding to said reference.

15. The method of claim 13 further comprising the step of
(d) adjusting one or more display properties of said associated image file.

16. A computer implemented method of tagging an electronic text message stored in a memory of a computing device comprising, by the computing device:
(a) associating at least one first text string within the electronic text message with at least one second text string; and
(b) storing said second text string and said association in said memory.

17. The method of claim 16 wherein the electronic text message is an instant message.

18. The method of claim 16 wherein said at least one first text string is only a portion of the electronic text message, and wherein said association includes a reference to at least a start position of said at least one first text string.

19. The method of claim 18 wherein the electronic text message is an instant message.

20. A computer readable storage medium having computer readable code embodied thereon, the computer readable code for creating an expressive electronic text message, the computer readable code comprising:
(a) program code for receiving a string of input characters; and
(b) program code for associating said string with an audio stream such that at least one character of said string is associated with at least one respective sound of said audio stream, thereby creating, for each said at least one character, a respective association;
wherein said at least one association is stored in the computer readable storage medium.

21. A computer readable storage medium having computer readable code embodied thereon, the computer readable code for adding expression to an electronic text message, the computer readable code comprising:
program code for associating an electronic text message with a computer readable image file, thereby creating an association of said electronic message with said computer-readable image,
wherein said association includes an instruction to output an image stored in said associated image file concurrently with, and in the background of, an output of said electronic text message.

22. A computer readable storage medium having computer readable code embodied thereon, the computer readable code for tagging an electronic text message, the computer readable code comprising:
program code for associating at least one first text string within the electronic text message with at least one second text string, thereby creating an association of said at least one first text string with said at least one second text string,
wherein said at least one second text string and said association is stored in the computer readable storage medium.
